(19) United States
(12) Patent Application Publication
(10) Pub. No.: US 2025/0333303 A1
(43) Pub. Date: Oct. 30, 2025

(54) PROCESS AND PLANT FOR PRODUCING SYNTHESIS GAS

(71) Applicant: Topsoe A/S

(72) Inventors: Arunabh SAHAI, Faridabad (IN); Kim AASBERG-PETERSEN, Allerød (DK); Per Juul DAHL, Vedbæk (DK); Thomas Sandahl CHRISTENSEN, Kgs. Lyngby (DK); Steffen Spangsberg CHRISTENSEN, Køge (DK)

(73) Assignee: Topsoe A/S, Kgs. Lyngby (DK)

(21) Appl. No.: 18/864,423

(22) PCT Filed: May 10, 2023
(86) PCT No.: PCT/EP2023/062324

§ 371 Date: Nov. 8, 2024

(30) Foreign Application Priority Data
May 12, 2022 (IN) 202211027380
Jun. 30, 2022 (DK) PA202200633

(51) Int. Cl. C01B 3/48; C01B 3/34

(52) U.S. Cl. CPC C01B 3/48; C01B 3/346; C01B 2203/0244; C01B 2203/0283; C01B 2203/0475; C01B 2203/0495; C01B 2203/0833; C01B 2203/085; C01B 2203/1241; C01B 2203/1258; C01B 2203/148

(57) ABSTRACT

Process and plant for producing a syngas and a hydrogen product from a hydrocarbon feed and improved carbon capture are provided, said process comprising the steps of: reforming a hydrocarbon feed by pre-reforming and autothermal reforming (ATR), thereby obtaining a syngas; shifting said syngas in a shift section; and wherein a portion of the shifted synthesis gas is recycled to the process, suitably to pre-reforming. No fired heater for preheating of hydrocarbon feed or for preheating of pre-reformed hydrocarbon feed is required.

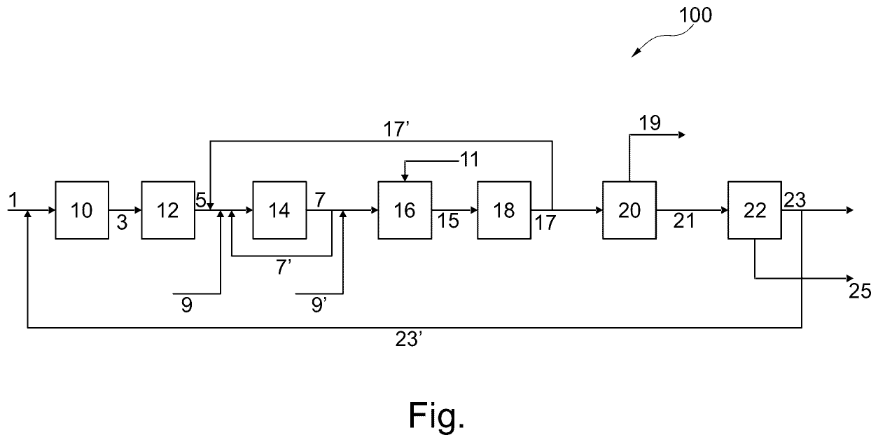

The present invention relates to a process and plant for producing synthesis gas (syngas) from a hydrocarbon feed, and optionally further producing hydrogen. The process and plant comprise pre-reforming, autothermal reforming, water gas shift conversion for producing the syngas, optionally also CO₂-removal and hydrogen purification for producing hydrogen. Embodiments of the invention include the recycling of shifted synthesis gas to the hydrocarbon feed stream prior to pre-reforming.

Applicant's WO 2022038089 discloses a plant and process for producing a hydrogen rich gas and improved carbon capture, in which the process comprises the steps of: reforming a hydrocarbon feed by optional pre-reforming, autothermal reforming (ATR), yet no primary reforming, thereby obtaining a synthesis gas; shifting said synthesis gas in a shift section including a high temperature shift step; removal of CO₂ upstream hydrogen purification unit, thereby producing a hydrogen rich stream and an off-gas stream, and where at least part of the off-gas stream is recycled to the process, thus to the ATR and optional pre-reforming, and/or to the shift section. The plant is arranged to provide an inlet temperature of said hydrocarbon feed to the ATR of below 600° C., such as 550° C. or 500° C. or lower, for instance 300-400° C. By having a lower ATR inlet temperature, suitably 550° C. or lower, such as 500° C. or lower, e.g. 300-400° C., the amount of heat required in a heater unit for preheating the hydrocarbon, e.g. a fired heater, is significantly reduced, thereby enabling a much smaller fired heater, or reducing the number of fired heaters. By having an inlet temperature to the ATR of 300-400° C., the use of a fired heater can be completely obliviated as well.

The above temperatures are lower than the typical ATR inlet temperatures of 600-700° C. and which are normally desirable to reduce oxygen consumption in the ATR. However, it would be desirable to be able to operate the ATR at lower inlet temperatures than the typical 600-700° C., yet no lower than 420° C., for instance no lower than 450° C. in order to be able to better sustain the combustion flame in the ATR driving the partial oxidation reactions therein.

It would also be desirable to provide an alternative process and plant for producing syngas, optionally further converting the syngas into a hydrogen product, based on an ATR without a dedicated fired heater which is normally used to preheat the hydrocarbon feed up to the desirable temperature for conducting desulfurization (including prior hydrogenation of the hydrocarbon feed), as well as to preheat the hydrocarbon feed prior to pre-reforming or autothermal reforming. A fired heater is a very large and cost intensive unit, requiring a considerable plot space and involving significant direct carbon emissions due to the flue gas generated therefrom by the burning of a fuel, typically natural gas. So, design and operation of a process and plant without a fired heater offers a significant reduction in capital and operating expenses and enables a drastic decrease in carbon emissions, thus significantly reducing the carbon footprint of the process and plant.

It would also be desirable to be able to provide higher heat integration in the process or plant for producing the syngas and optionally the hydrogen product.

The present invention present solutions to the above and other problems.

Accordingly, in a first aspect, the invention is a process for producing a synthesis gas from a hydrocarbon feed, comprising the steps:
i) pre-reforming the hydrocarbon feed for producing a pre-reformed hydrocarbon feed;
ii) autothermal reforming of the pre-reformed hydrocarbon feed for producing a raw synthesis gas;
iii) water gas shifting of the raw synthesis gas for producing a shifted synthesis gas as said synthesis gas;
and recycling a first portion of the shifted synthesis gas by combining it with the hydrocarbon feed of step i); wherein the first portion of the shifted synthesis gas which is being recycled is shifted synthesis gas from which water has been removed in a water separation step.

As used herein, the term “comprising”” includes “comprising only”, i.e. “consisting of”.

As used herein, the term “suitably” is used interchangeably with the term “optionally”, which refers to a particular embodiment of the invention.

As used herein, the term “synthesis gas” is used interchangeably with the term “syngas”. As is well-known in the art, a synthesis gas is a gas containing carbon oxides (CO and CO₂) and H₂.

As used herein, the term “first aspect of the invention” means a process according to the invention; the term “second aspect of the invention” means a plant, i.e. process plant, according to the invention.

As used herein, the term “present invention” or “invention”, may be used interchangeably with the term “present application” or “application”, respectively.

As used herein, the first portion of the shifted synthesis gas which is being recycled is also referred to as “shifted syngas recycle”.

It would be understood that said first portion of the shifted synthesis gas which is being recycled, i.e. said shifted syngas recycle, is a portion directly withdrawn from said water separation step. Hence, the shifted syngas recycle is directly supplied to the hydrocarbon feed of step i). By the term “directly supplied” is meant that there are no intermediate steps or units substantially changing the composition of the stream.

The first portion first portion of the shifted synthesis gas which is being recycled has not been subjected to CO₂-removal and subsequent hydrogen enrichment.

A second portion is optionally subjected to CO₂-removal, and/or hydrogen enrichment, as it will become apparent from a below embodiment, or as for instance illustrated in the appended FIGURE.

Hence, by the present invention and thus contrary to the prior art, there is no recycle of shifted syngas after an acid gas removal (CO₂ removal) and/or hydrogen purification step. The latter implies recycle of e.g. a purer hydrogen stream produced after CO₂ removal and hydrogen purification in e.g. a pressure swing adsorption (PSA) unit. In the present invention, the first portion of the shifted synthesis gas is the gas after cooling and then water removal (drying), yet before CO₂ removal and/or hydrogen purification; hence comprising a decent amount of H₂ and CO₂ so as to provide an exotherm in the pre-reforming via methanation, which avoids the requirement of any heat input to preheat the pre-reformed hydrocarbon feed before being fed to the autothermal reforming. Such preheating according to the prior art is conducted via a fired heater or a gas heated reformer. The latter is also traditionally used as primary reforming step, which inherently is an endothermic step thus requiring heat, for preparing the syngas for subsequent autothermal reforming.

In the present invention, the portion of the shifted synthesis gas which is being recycled has a significant content of H₂ and CO₂, e.g. more than 70 vol. % H₂ and more than 25 vol. % CO₂, which enables the occurrence of the exothermic methanation reaction, CO₂+4 H₂═CH₄+2 H₂O, over a pre-reforming catalyst utilized in the pre-reforming. Normally, pre-reforming or reforming is highly endothermic by which methane in the hydrocarbon feed is converted under the presence of steam into carbon oxides (CO, CO₂) and hydrogen. Thus, normally the inlet temperature of the hydrocarbon feed gas to the pre-reforming step is about 450° C. and the outlet temperature about 420° C. The methanation reaction is the reverse reaction and thus exothermic. The exotherm in the pre-reforming enables conducting the pre-reforming at lower temperatures than normal, for instance the inlet temperature may be about 420° C., while at the same time bringing the temperature of the pre-reformed hydrocarbon feed up to a level acceptable for the subsequent autothermal reforming, for instance the outlet temperature from pre-reforming and thereby also the inlet temperature to the autothermal reforming may be 420° C. or 450° C. or higher, for instance in the range 450-480° C.

Operating the ATR inlet at 420 or 450° C. or slightly higher such as 460 or 470° C., enables better sustaining the combustion flame in the ATR driving the partial oxidation reactions therein, while at the same time providing a reliable and a stable plant performance along with the cost saving achieved by eliminating the fired heater which is normally required for pre-heating the hydrocarbon feed prior to pre-reforming and/or prior to autothermal reforming.

Furthermore, by the invention, in step ii) the pre-reformed hydrocarbon feed is not preheated, for instance by a fired heater, prior to conducting the autothermal reforming.

The absence of a fired heater enables that less than 3 wt %, for instance less than 1 wt % or 0 wt % of the carbon in the hydrocarbon feed ends up as CO₂ in flue gas. Hence, in the process and plant according to the invention, a fired heater is not provided. As a result, there are no direct emissions from the plant, e.g. 0 wt % of the carbon in the hydrocarbon feed ends up as CO₂ in the flue gas. The carbon in the hydrocarbon feed is suitably withdrawn as CO₂-product by a CO₂-removal step in a CO₂-removal section arranged downstream, such as an amine wash CO₂ removal unit, as it will become apparent from a below embodiment. In other words, by the invention, the use of a fired heater for e.g. preheating hydrocarbon feed is obviated, hence no flue gas is generated so there are no carbon emissions from a fired heater. The hydrocarbon feed carbon is not emitted as CO₂, but recovered as CO₂-product in the CO₂-removal section. Thereby, there are no carbon emissions from hydrocarbon feed or fuel from the plant. The CO₂-product, herein also referred to as CO₂-rich stream, may be captured and/or utilized according to known techniques, such as carbon capture and utilization (CCU) or carbon capture and storage (CCS), or a combination thereof (CCUS).

The flue gas from a fired heater would normally be emitted at low pressure, thus the energy and capital cost for CO₂-removal from the low-pressure flue gas is high. For instance, in an amine wash CO₂ removal unit, the energy requirement for compressing the flue gas and energy required for regenerating the CO₂ is significantly higher, which otherwise would be lesser if CO₂ is recovered from the shifted syngas. Moreover, additional unit operations are needed to cool and purify the flue gas which increases the capital expenses. The impurities in flue gas typically are SOₓ and NOₓ which are not suitable in an amine wash type CO₂ removal unit. Thus, in an embodiment, the present invention removes CO₂ from the process gas itself, more specifically from the shifted synthesis gas. The invention enables therefore also reducing the capital expenses in order to produce a high purity H₂ stream, e.g. with 99.9 vol. % H₂, and 90% or more carbon capture.

In an embodiment, said first portion of the shifted synthesis gas is 15% or less, such as 10% or less, e.g. 2-8%, of the volume flow of shifted synthesis gas. In a particular embodiment, the shifted synthesis gas is withdrawn from a medium or low temperature shift stage of the water gas shifting step iii), then cooled and dried i.e. by directing the shifted synthesis gas to a cooling and said water removal step, for instance water removal in a process condensate separator (PC-separator). The recycle of cooled and dried shifted syngas is required in small quantities, such as <15%, only. Thereby, this syngas recycle is cost effective because the pressure increase required in the recycle is up-to only a few bars and involving a small gas flow only. The power of a shifted synthesis gas recycle compressor is thus kept at a minimum.

Suitably, the hydrocarbon feed, herein also referred as hydrocarbon feed gas, is natural gas.

In an embodiment, the process is absent of a primary reforming step requiring heat input, said primary reforming step being any of steam methane reforming (SMR), and convection reforming. Hence, the pre-reformed hydrocarbon feed is directly supplied to the autothermal preforming step. By the term “directly supplied” is meant that there are no intermediate steps or units substantially changing the composition of the stream.

The process or plant is provided without a prior primary reforming step of the pre-reformed hydrocarbon feed, and requiring heat input, such as SMR, before conducting the autothermal reforming. Accordingly, the process or plant is without i.e. is absent of a steam methane reformer unit (SMR) upstream the ATR. The primary reforming unit may also be a convection reforming unit such as a gas heated reforming unit i.e. a heat exchange reformer (HER). Accordingly, the reforming section of the plant comprises an ATR and a prereforming unit, yet there is no steam methane reforming (SMR) unit, i.e. the use of e.g. a conventional SMR (also normally referred as radiant furnace, or tubular reformer), or another primary reforming unit such as convection reforming unit e.g. a heat exchange reformer (HER) such as a HER arranged in series with the ATR, is omitted. Thereby, a reduction in plant size is also achieved as well as reduction in attendant operating expenses.

In another embodiment, the process or plant is provided without, i.e. is absent of, a subsequent reforming unit, such as convection reforming unit e.g. a HER arranged downstream the ATR, or arranged in parallel with the ATR. Again, a reduction in plant size is achieved as well as a reduction in operating costs.

In an embodiment, the process further comprises:
prior to step i), desulfurizing the hydrocarbon feed i.e. a desulfurizing step; suitably the desulfurizing comprising hydrogenation and subsequent sulfur absorption; wherein step iii) comprises a high temperature shift (HTS) step for producing a first shifted synthesis gas, and optionally a subsequent medium and/or low temperature shift step (MTS and/or LTS) step, for producing the shifted synthesis gas; and wherein prior to the desulfurizing, the process further comprises: preheating the hydrocarbon feed by indirect heat exchange with shifted synthesis gas from step iii), said indirect heat exchange being by the cooling in one or more heat exchangers, of the first shifted synthesis gas stream (synthesis gas from the HTS step); or by indirect heat exchange with superheated steam generated from heat recovering in step iii), i.e. water gas shifting step, in which said heat recovering comprises cooling a portion of the first shifted synthesis gas by directing it to a steam superheater for thereby generating said superheated steam.

Accordingly, the preheating of the hydrocarbon feed prior to desulfurizing the hydrocarbon feed, i.e. prior to the desulfurizing step, is conducted by other means than a fired heater.

Normally, the preheating of the hydrocarbon feed prior to desulfurization, more specifically prior to the hydrogenation, is conducted in a fired heater by passing the hydrocarbon feed gas through one or two pre-heating units, e.g. coils, arranged within the fired heater, thus bringing the temperature from about 100° C. to about 380° C. The hydrogenation is conducted in a hydrogenation unit (hydrogenator) and subsequently, the thus hydrogenated hydrocarbon gas is directed to sulfur absorption in a sulfur absorption unit (sulfur absorber), as is well known in the art. The thus desulfurized hydrocarbon feed exits the sulfur absorber at a lower temperature, for instance about 365° C.

It would be understood, that for the purposes of the present patent application, the terms “desulfurizing” and “desulfurization” are used interchangeably.

By the invention, rather than utilizing a fired heater, heat integration in the process or plant is provided by the preheating of the hydrocarbon feed with e.g. the shifted synthesis gas from step iii), i.e. water gas shifting. Shifted gas, suitably the first shifted synthesis gas withdrawn from a high temperature shift (HTS) step therein, is cooled by heat exchange with the hydrocarbon feed in a first and optionally also a second feed heat exchanger, i.e. a first and optionally second feed preheater, thereby bringing the temperature of the hydrocarbon feed gas from about 100° C. to about 380° C. at the inlet of the hydrogenator.

The preheating of the hydrocarbon feed by other means than a fired heater may also be by indirect heat exchange with superheated steam generated from heat recovering in step iii), i.e. water gas shifting step, as recited above. Thereby, instead of having hydrocarbon feed pre-heating downstream HTS, the shifted syngas is used to generate more superheated steam and then this additional superheated steam duty is utilized for pre-heating the hydrocarbon feed.

In a particular embodiment, after desulfurizing the hydrocarbon feed, the process comprises further preheating the hydrocarbon feed by indirect heat exchange with superheated steam generated from heat recovering in step iii) i.e. water gas shifting step, in which said heat recovering comprises cooling a portion of the first shifted synthesis gas by directing it to a steam superheater for thereby generating said superheated steam.

Normally, the desulfurized hydrocarbon feed gas, typically at 365° C., is combined with steam, including superheated steam at high temperature which is added directly, thus increasing the temperature of desulfurized hydrocarbon feed gas to close to 400° C. The superheated steam is generated in a steam superheater of typically an auxiliary boiler. The temperature of the desulfurized hydrocarbon feed gas is further increased to 450° C., which is the normally desired inlet temperature for pre-reforming, by preheating in one or more preheaters, e.g. coils, arranged in a fired heater.

According to this embodiment of the invention, rather than utilizing a fired heater, further heat integration in the process or plant is enabled by the indirect preheating of the hydrocarbon feed after desulfurization with superheated steam. Thus, a pre-reformer feed preheater, i.e. a heat exchanger using the superheated steam as heat exchanging medium, is provided. The superheated steam generated from heat recovering in the water gas shifting step, having for instance a temperature of 440° C., preheats the desulfurized hydrocarbon feed gas from about 365° C. to about 420° C.

Accordingly, the preheating of the hydrocarbon feed after desulfurizing the hydrocarbon feed, is conducted by other means than a fired heater.

Hence, in a particular embodiment, step iii) comprises a high temperature shift (HTS) step for producing a first shifted synthesis gas, and optionally a subsequent medium and/or low temperature shift step (MTS and/or LTS) step, for producing the shifted synthesis gas.

The exit gas temperature of the HTS step is in the range 450-500° C., thus suitably utilized for indirect heat exchange for generating the superheated steam in the steam superheater. Again, the need of using a fired heater or auxiliary boiler, typically required for providing such superheated steam, is eliminated. Further heat integration without resorting to external fuel sources, such as the use of natural gas in the fired heater, is thus achieved, while at the same time significantly reducing the carbon footprint of the process or plant.

In an embodiment step i) comprises recycling a portion of the pre-reformed hydrocarbon by combining it with the hydrocarbon feed.

In a particular embodiment, the process further comprises:
prior to step i), desulfurizing the hydrocarbon feed, and the pre-reformed hydrocarbon feed is combined with the preheated hydrocarbon feed after desulfurizing.

These particular embodiments may be regarded as a “short recycle”, since part of the exit gas from the pre-reformer is returned back to the hydrocarbon feed to the pre-reformer.

Normally as described above, in pre-reforming, the inlet gas enters at about 450° C. and after being pre-reformed it exits the pre-reformer at about 420° C. The pre-reformed gas is then preheated in a fired heater to the required inlet temperature of the ATR, typically 600-700° C. Normally also, there is no such “short recycle” of the exiting gas from the pre-reformer, since this conveys cooling the inlet gas to the pre-reformer and would also imply a higher duty in the fired heater for further preheating of the exit gas from the pre-reformer for the subsequent autothermal reforming.

In contrast herewith, the present invention in the above particular embodiments purposely also provides a “short recycle” by recycling a portion of the exit gas from the pre-reformer back to the inlet of the pre-reformer, thereby now enabling further preheating of the hydrocarbon feed gas upon entering the pre-reformer, suitably the further preheating of the preheated hydrocarbon stream after desulfurizing. Further heat integration is thereby achieved. The pre-reformed gas exits at a higher temperature than at the inlet, for instance the exit gas temperature is about 450° C. while the inlet temperature is 420° C., due to the exotherm generated during the pre-reforming.

Suitably, the portion of the pre-reformed hydrocarbon being recycled is 10-30%, such as 15-20% of the volume flow of the pre-reformed hydrocarbon.

In a particular embodiment, said portion of the pre-reformed hydrocarbon feed is recycled by means of an ejector, said ejector receiving said portion of the pre-reformed hydrocarbon feed as driving fluid, and pressurized steam as the motive fluid; and optionally, said portion of the pre-reformed hydrocarbon feed is combined with the hydrocarbon feed after combining the first portion of the shifted synthesis gas being recycled (shifted syngas recycle) with the hydrocarbon feed, i.e. the mixing point of the pre-reformed hydrocarbon feed recycle is downstream the mixing point of the shifted syngas recycle.

The provision of an ejector, which has no moving parts, is a simple and inexpedient solution for providing the mixing of the recycled stream with the pressurized steam.

In an embodiment, the process further comprises adding pressurized steam to the preheated hydrocarbon feed after desulfurizing, suitably also after combining the first portion of the shifted synthesis gas with the hydrocarbon feed. Hence, the mixing point of the pre-reformed hydrocarbon feed with the pressurized steam is downstream the mixing point of the shifted syngas recycle. Suitably also, the preheated hydrocarbon feed after desulfurizing and the pressurized steam are combined before recycling the portion of the pre-reformed hydrocarbon. The pressurized steam is for instance supplied at about 50 barg and about 430° C., thus enabling the increase in temperature of the stream being fed to the prereforming to the desired level of for instance about 420° C. The pressurized steam is suitably the same stream from which a stream is diverted and used as the pressurized steam of the ejector.

The shifted syngas recycle, having for instance a temperature of 350-370° C. reduces thereby the temperature of the preheated hydrocarbon feed after desulfurization to for instance about 410° C. The recycle stream provided by the ejector is suitably about 450° C. and is added downstream the mixing point of the shifted syngas recycle, thus enabling at least partly to increase the temperature to the desired inlet temperature to the pre-reformer, e.g. 420° C.

In an embodiment, the shifted syngas recycle, as recited earlier, is cooled and dried shifted syngas. Accordingly, the first portion of the shifted synthesis gas which is being recycled (shifted syngas recycle) is shifted synthesis gas from which water has been removed in a water separation step, suitably in a process condensate separator, thus resulting in a dry shifted synthesis gas stream, i.e. a water-depleted shifted synthesis gas stream. The presence of water in the shifted syngas recycle disfavors among other things the desired methanation reaction CO₂+4 H₂═CH₄+2 H₂O in the pre-reforming step.

Then the shifted syngas recycle may be compressed in a recycle compressor and heated in one or more heat exchangers using steam as heat exchanging medium to preheat the shifted syngas recycle to e.g. the above-mentioned 350-370° C. before mixing it with the hydrocarbon feed to the pre-reforming. For instance, the shifted syngas recycle is preheated by indirect heat exchange with steam generated in the process, including e.g. superheated steam. From the process condensate separator (PC-separator), a second portion of the shifted syngas which may be directed to a CO₂-removal step, is for instance at about 60° C. From the PC-separator, a first portion of the shifted syngas is diverted as the shifted syngas recycle, which may then also be at about 60° C. Again, the preheating of the shifted syngas recycle elevates the temperature to e.g. about 360° C. prior to combining with the optionally desulfurized hydrocarbon feed upstream the pre-reformer.

Suitably also, the first portion of the shifted synthesis gas which is being recycled (the shifted syngas recycle), is shifted synthesis gas from an MTS and/or LTS step in step iii) i.e. the water gas shifting step. This shifted synthesis gas is the one richest in hydrogen from the shifting step, e.g. containing the previously mentioned about 70 vol. % hydrogen and about 25 vol % carbon dioxide, and thus advantageously utilized in the recycle to the hydrocarbon feed gas, in particular to the pre-reforming step. The H₂ and CO₂ content in the shifted syngas promotes the exothermic methanation reaction in the pre-reforming step. The shifted syngas recycle is thus required in small quantities, such as <10% of the flow, as explained farther above. Hence, in an embodiment, said first portion of the shifted synthesis gas which is being recycled has more than 70 vol. % H₂ and more than 25 vol. % CO₂.

In an embodiment, the process further comprises:
iv) CO₂-removal of a second portion of the shifted synthesis gas stream for producing a CO₂-depleted shifted synthesis gas; and optionally
v) hydrogen enrichment of the shifted synthesis gas or the CO₂-depleted shifted synthesis gas in a hydrogen purification unit for producing the hydrogen product and an off-gas stream; and wherein there is no recycling of off-gas stream, such as a portion thereof, to any of steps i)-iv).

Thereby, a process which is simple, highly energy efficient, and with a low carbon footprint is provided for the production of hydrogen including hydrogen which may be used in the process, since compared to the prior art, at least the need of fire heaters for i.a. preheating the hydrocarbon feed, is eliminated.

For instance, in step iv) the CO₂-depleted shifted synthesis gas stream is hydrogen-rich, having e.g. 97 mole % or more H₂, and less than 100 ppmv CO₂ such as 50 ppmv or less. A portion of this stream may therefore be used as a H₂-recycle stream to the hydrocarbon feed, thereby providing hydrogen required in e.g. the hydrogenation of the desulfurizing step. For instance also, in step v) the hydrogen product has 99 mole % or more H₂, such as 99.9 mole %, with no detectable CO₂. A portion of the hydrogen product may also be used as H₂-recycle stream.

From the CO₂-removal step i.e. from the CO₂-removal section, a CO₂-rich stream is also withdrawn as the CO₂-product, for instance containing 95 vol. % (mole %) or more, such as 99.5 vol. % of carbon dioxide.

Furthermore, there is no recycling of off-gas stream to any of steps i)-iv) of the process. Hence, off-gas from the hydrogen enrichment step v) e.g. in a hydrogen purification unit such as a PSA-unit, is not combined with process gas. Thus, the off-gas stream is not combined with e.g. the hydrocarbon feed of step i), or with the pre-reformed hydrocarbon feed of step ii), or with the raw synthesis gas of step ii), or with the shifted synthesis gas of step iii). Thereby, a simpler process and plant layout is provided, thus also with lower capital and operating expenses, as there is no need of e.g. providing an off-gas recycle compressor and attendant piping, as well as means for heating the off-gas recycle to the required temperatures of any of the process steps.

In an embodiment, the hydrocarbon feed is supplied to a feed gas compressor prior to said pre-reforming step or prior to said desulfurizing, and:
said recycling in step iii) comprises combining said first portion of the shifted synthesis gas stream with the hydrocarbon feed prior to it being supplied to the feed gas compressor, i.e. the shifted syngas recycle is combined with the hydrocarbon feed prior to it being supplied to the feed gas compressor (in other words, the shifted syngas recycle is taken up-to feed gas compressor suction).

Thereby, the need of providing a dedicated shifted syngas recycle compressor is eliminated. Furthermore, while a portion of the CO₂-depleted shifted synthesis gas stream or a portion of the hydrogen product may be recycled to the hydrocarbon feed, i.e. as H₂-recycle, this H₂-recycle may not be required when the shifted syngas recycle is taken up-to the feed gas compressor suction, thus representing a significant further advantage of this embodiment, as the process and plant becomes much simpler.

Where the first portion of the shifted synthesis gas which is being recycled is sent to the hydrocarbon feed prior to it being supplied to the feed gas compressor, thus upstream the feed gas compressor, only this feed compressor is required. If the first portion of the shifted syngas which is being recycled is combined with the hydrocarbon feed being directed to the pre-reforming i.e. to inlet pre-reformer, a dedicated shifted syngas recycle compressor is needed.

The H₂ recycle may be provided when the shifted syngas recycle is added to the inlet pre-reformer. Accordingly, in another embodiment, the process further comprises: prior to step i), desulfurizing the hydrocarbon feed, and said recycling in step iii) comprises combining said first portion of the shifted synthesis gas with the hydrocarbon feed after desulfurizing; the hydrocarbon feed is supplied to a feed gas compressor prior to said pre-reforming step or prior to said desulfurizing, and the process further comprises recycling a portion of the CO₂-depleted shifted synthesis gas stream or a portion of the hydrogen product to the hydrocarbon feed prior to it being supplied to the feed gas compressor.

Thereby, the need of providing a dedicated hydrogen recycle compressor, is also eliminated. Further, integration of process streams is thus provided, with no need of resorting to external sources for e.g. providing the required hydrogen in the hydrogenator. The energy efficiency of the process or plant increases; while significant costs (capital and operating expenses) typically associated with the provision of such recycle compressor(s) are eliminated.

Normally, a hydrogen recycle is provided by means of a hydrogen recycle compressor which adds the hydrogen product from e.g. a Pressure Swing Adsorption unit (PSA unit) to a point downstream the feed gas compressor prior to pre-heating to the hydrogenator inlet temperature, this typically being about 380° C. In contrast herewith, the hydrogen recycle may be added to the hydrocarbon feed upstream the feed gas compressor, thus, again, avoiding the need of providing such hydrogen recycle compressor.

In an embodiment, the pre-reforming step i) is conducted in an adiabatic pre-reformer with an inlet temperature of the hydrocarbon feed gas which is the range 380-430° C., for instance 420° C.; and the autothermal reforming step ii) is conducted in an autothermal reformer (ATR) with an inlet temperature of the pre-reformed hydrocarbon feed which is in the range 420-480° C., for instance 450° C., substantially corresponding to the temperature of the pre-reformed hydrocarbon feed exiting the pre-reformer.

It would be understood that the term “substantially corresponding to the temperature of the pre-reformed hydrocarbon feed exiting the pre-reformer” means that the temperatures are not necessarily exactly the same, but within e.g. 10° C. or less, e.g. less than 5° C. The pre-reformed hydrocarbon feed, prior to entering the ATR, may be admixed with steam, so there is a minor decrease in temperature, for instance said less than 5° C.

Hence, the pre-reformed hydrocarbon feed is not preheated, for instance by a fired heater, prior to conducting the autothermal reforming.

Accordingly, the preheating of the hydrocarbon feed prior to desulfurizing the hydrocarbon feed, or after desulfurizing the hydrocarbon feed yet prior to pre-reforming, or after prereforming yet prior to autothermal reforming, is conducted by other means than a fired heater.

Apart from the benefits associated with the elimination of the fired heater, including cost savings and more importantly significant reduction in carbon emissions, operating the ATR inlet at 420-480° C., or 450-480° C. provides a reliable and a stable plant performance.

In an embodiment, the steam-to-carbon molar ratio (S/C ratio) in the pre-reforming step i) is 1.0 or lower, such as 0.8 or lower, for instance 0.6 or lower, such as 0.5.

It would be understood, that the term “S/C ratio in the pre-reforming step i)” or “S/C ratio in the pre-reformer” means steam-to-carbon molar ratio, defined by the molar ratio of all steam added to the hydrocarbon feed including any water in the shifted synthesis gas being recycled, to all the carbon in hydrocarbons in the hydrocarbon feed gas.

For instance, the pre-reforming step i) is conducted at S/C ratio of 1.0 or lower, such as 0.8 or lower, for instance 0.6 or lower, such as 0.5, and the hydrocarbon feed temperature in the pre-reforming step i), i.e. the inlet temperature to the pre-reformer is 380-430° C., such as 400-430° C.

While it is known in the art, such as applicant's WO 2022038089, to operate the ATR at low S/C ratio and low inlet temperature (below 600° C., such as 550° C. or 500° C. or lower, for instance 300-400° C.) the associated benefit of now combining a low value of S/C, e.g. 0.5, in the pre-reformer with a low inlet temperature to the pre-reformer, e.g. 400° C., is that the preheating demand prior to the pre-reformer is further reduced due to reduced flows, which is easily met by the heat integration and yet again without the need of an external heating source such as the use of natural gas in a fired heater.

In the ATR, additional steam may be added, for instance together with the oxygen stream to the ATR, thus generating a S/C ratio in the ATR which is slightly higher. For instance, if S/C ratio in the pre-reformer is 0.5, the S/C ratio in the ATR is 0.6 or higher.

In an embodiment, the process comprises preheating by electric heating, i.e. in an electric heater, of said hydrocarbon feed or pre-reformed hydrocarbon feed prior to conducting the autothermal reforming step ii). Suitably, the electrical heater is powered by electricity from renewable sources such as solar, wind or hydropower, optionally from a thermonuclear source. This is advantageous during start-up operation of the process or plant in order to be able to reach the temperatures required in the ATR, or other process units.

Suitably, the ATR operates with an inlet temperature of the pre-reformed hydrocarbon feed of 420° C. or higher, or 450° C. or higher, such as 450-480° C.; a pressure range of 35-45 barg, Suitably also, the steam-to-carbon ratio in the ATR is 0.5 or higher, such as 0.6 or higher, or such as 0.8 or higher, yet said steam-to-carbon ratio being not greater than 2.0. Operating the process or plant at these low steam-to-carbon ratios in the ATR enables lower energy consumption and reduced equipment size as less steam/water is carried over in the plant.

As used herein the term “steam-to-carbon ratio in the ATR” (alternatively denoted S/C-ratio or steam/carbon ratio) means steam-to-carbon molar ratio in the ATR, is defined by the molar ratio of all steam added to the hydrocarbon feed and the ATR, i.e. excluding any steam added to the shift section downstream, to all the carbon in hydrocarbons in the pre-reformed feed gas (pre-reformed hydrocarbon feed). More specifically, the steam/carbon ratio is defined as the ratio of all steam added to the reforming section upstream the shift section e.g. the high temperature shift section, i.e. steam which may have been added to the reforming section via the feed gas, oxygen feed, by addition to the ATR and the carbon in hydrocarbons in the feed gas (hydrocarbon feed) to the reforming section on a molar basis. The steam added includes only the steam added to the ATR and upstream the ATR.

The term “reforming section” means the section of the plant upstream water gas shift, which includes the hydrogenator, sulfur absorber, pre-reformer, and ATR. Also, for the purposes of the present application, the term “desulfurization section” comprises the hydrogenator and sulfur absorber.

In another general embodiment of the first aspect, the invention is a process for producing a hydrogen product from a hydrocarbon feed, comprising the steps:
i) desulfurizing and pre-reforming the hydrocarbon feed for producing a pre-reformed hydrocarbon feed;
ii) autothermal reforming of the pre-reformed hydrocarbon feed for producing a raw synthesis gas;
iii) water gas shifting of the raw synthesis gas stream for producing a shifted synthesis gas and dividing the shifted synthesis gas into a first and second portion;
iv) CO₂-removal of the second portion of shifted synthesis gas stream for producing a CO₂-depleted shifted synthesis gas;
v) hydrogen enrichment of the shifted synthesis gas or the CO₂-depleted shifted synthesis gas in a hydrogen purification unit for producing the hydrogen product and an off-gas stream;
   wherein
the hydrocarbon feed is supplied to a feed gas compressor prior to said desulfurizing and pre-reforming step, and wherein the process further comprises:
   combining the first portion of the shifted synthesis gas with the hydrocarbon feed prior to it being supplied to the feed gas compressor; and/or
   combining the first portion of the shifted synthesis gas with the hydrocarbon feed in between said desulfurizing and pre-reforming step.

Any of the above recited embodiments and associated benefits may be combined with this general embodiment of the first aspect.

In a second aspect, there is also provided a plant for producing a synthesis gas from a hydrocarbon feed, comprising:
a pre-reformer arranged to receive the hydrocarbon feed, for producing a pre-reformed hydrocarbon feed;
a feed gas compressor arranged upstream the pre-reformer, for directing the hydrocarbon feed to the pre-reformer;
an autothermal reformer (ATR) arranged to receive the pre-reformed hydrocarbon feed and convert it to a raw synthesis gas;
a water gas shift section, (WGS section), arranged to receive the raw synthesis gas from the ATR and shift it in at least a high temperature shift step (HTS step), thereby providing a shifted synthesis gas as said synthesis gas;
   wherein said plant is absent of a fired heater for preheating the hydrocarbon feed or the pre-reformed hydrocarbon feed;
   wherein said plant is arranged to feed a first portion of the shifted synthesis gas to a point upstream the pre-reformer; i.e. the plant is provided with a conduit for recycling a first portion of the shifted synthesis gas stream to a point upstream the pre-reformer.

It would be understood that said first portion of the shifted synthesis gas fed to the pre-reformer is also referred to as “shifted syngas recycle”.

As in connection with the first aspect (process) of the invention, said shifted syngas recycle is a portion directly withdrawn from a water separation step e.g. in a process condensate separator. Hence, the shifted syngas recycle is directly supplied to a point upstream the pre-reformer. By the term “directly supplied”, as already recited in connection with the first aspect of the invention, it is meant that there are no intermediate steps or units substantially changing the composition of the stream. It would also be understood that the use of “to feed” and “to supply” are used interchangeably.

In an embodiment according to the second aspect of the invention, the plant further comprises a desulfurization section, suitably comprising a hydrogenator and sulfur absorber, arranged upstream the pre-reformer for desulfurizing the hydrocarbon feed. Accordingly, there is also provided a plant for producing a synthesis gas from a hydrocarbon feed, comprising:
a pre-reformer arranged to receive the hydrocarbon feed, for producing a pre-reformed hydrocarbon feed;
a desulfurization section comprising a hydrogenator and sulfur absorber arranged upstream the pre-reformer for desulfurizing the hydrocarbon feed;
a feed gas compressor arranged upstream the pre-reformer or upstream the desulfurization section, for directing the hydrocarbon feed to the pre-reformer or the desulfurization section;
an autothermal reformer (ATR) arranged to receive the pre-reformed hydrocarbon feed and convert it to a raw synthesis gas;
a water gas shift section (WGS section) arranged to receive the raw synthesis gas from the ATR and shift it in at least a high temperature shift step (HTS step), thereby providing a shifted synthesis gas as said synthesis gas;
   wherein said plant is absent of a fired heater for preheating the hydrocarbon feed or the pre-reformed hydrocarbon feed;
   wherein said plant is arranged to feed a first portion of the shifted synthesis gas to a point upstream the pre-reformer; i.e. the plant is provided with a conduit for recycling a first portion of the shifted synthesis gas stream to a point upstream the pre-reformer.

Thus, according to the second aspect, the invention is an ATR-based syngas producing plant without a dedicated fired heater which is normally used to preheat the hydrocarbon feed up to the desirable temperature of reforming section comprising the desulfurization section, pre-reformer and ATR. A fired heater is a large and very cost intensive unit, requiring considerable plot space in the plant and involving significant direct carbon emissions. The plant according to the present invention, without a fired heater, enables reduction the attendant carbon emissions as well as costs (capital and operating expenses).

In an embodiment, said plant further comprises:
a CO₂ removal section, arranged to receive a second portion of the shifted synthesis gas from said WGS section and separate a CO₂-rich stream therefrom, thereby providing a CO₂-depleted shifted synthesis gas,
a hydrogen purification unit, arranged to receive said second portion of the shifted synthesis gas or said CO₂-depleted shifted synthesis gas from said CO₂ removal section, and separate it into the hydrogen product and an off-gas stream;
   and wherein the plant is absent of a conduit and/or off-gas recycle compressor for directing at least a portion of the off-gas stream to any of said desulfurization section, pre-reformer, ATR, and WGS section.

Thereby, the second aspect of the invention provides also an ATR-based hydrogen producing plant where there is no recycling of off-gas to the different process units in the plant. Hence, off-gas from the hydrogen purification unit, such as a PSA-unit, is not combined with process gas being passed to any of the upstream units: the off-gas stream is not combined with e.g. the hydrocarbon feed being directed to the desulfurization section or to the pre-reformer, or with the pre-reformed hydrocarbon feed being directed to the ATR, or with the raw synthesis gas being directed to the shift section, or with shifted synthesis gas in the shift section. Thereby, a simpler plant layout is provided, thus also with lower capital and operating expenses, as there is no off-gas recycle compressor and attendant piping, as well as no means for heating the off-gas recycle to the required temperatures of any of the process steps.

In an embodiment, said plant is arranged to feed the first portion of the shifted synthesis gas to the inlet of the pre-reformer, and the plant is further arranged to feed a portion of the CO₂-depleted shifted synthesis gas; or a portion of the the hydrogen product to the hydrocarbon feed, upstream the feed gas compressor. Accordingly, the plant comprises a conduit for recycling the first portion of the shifted synthesis gas to the inlet of the pre-reformer; and the plant further comprises a conduit to feed a portion of the CO₂-depleted shifted synthesis gas, or a conduit to feed a portion of the the hydrogen product to the hydrocarbon feed, upstream the feed gas compressor.

The provision of a dedicated hydrogen recycle compressor is thereby eliminated.

In a particular embodiment, the plant is absent of a shifted syngas recycle compressor and/or a hydrogen recycle compressor.

In an embodiment, the plant is arranged to feed, i.e. to recycle, the first portion of the shifted synthesis gas to the hydrocarbon feed upstream the feed gas compressor; and suitably, the plant is absent of means, such as conduit and/or a recycle compressor, to feed a portion of the CO₂-depleted shifted synthesis gas or a portion of the hydrogen product to the hydrocarbon feed, upstream the feed gas compressor. Accordingly, the plant comprises a conduit for recycling the first portion of the shifted synthesis gas to the hydrocarbon feed upstream the feed gas compressor.

By the plant being arranged to feed a portion of the shifted synthesis gas to the hydrocarbon feed upstream the feed gas compressor (in other words, the shifted syngas recycle is taken up-to feed gas compressor suction), there is no need for a H₂-recycle e.g. by feeding a portion of the the hydrogen product to the hydrocarbon feed. A much simpler plant layout is thereby provided.

In addition, the provision of a dedicated shifted syngas recycle compressor is eliminated. As recited in connection with the first aspect of the invention, further integration of process streams is thereby provided, with no need of resorting to external sources for e.g. providing the required hydrogen in the hydrogenator of the desulfurization section. The energy efficiency of the process or plant increases; while significant costs (capital and operating expenses) typically associated with the provision of such recycle compressor(s) are eliminated.

In an embodiment, the WGS section comprises:
a high temperature shift unit (HTS unit), as well as a medium temperature shift unit (MTS unit) or a low temperature shift unit (LTS unit);
a downstream section comprising one or more heat exchangers for the cooling of shifted synthesis gas withdrawn from the MTS or LTS unit, and a process condensate separator (PC-separator) for the separation of a process condensate (water) from the shifted synthesis gas, thereby providing a cooled and dried shifted synthesis gas; and means, such as a juncture or joint, for diverting thereof said first portion of the shifted synthesis gas fed to upstream the pre-reformer, and optionally also said second portion of the shifted synthesis gas fed to the CO₂-removal section.

Thereby, there is a higher content of H₂ and CO₂ content in the shifted syngas, for instance the more than 70 vol. % hydrogen and more than 25 vol. % carbon dioxide, which results in the methanation reaction taking place in the pre-reformer, which is an exothermic reaction and thus results in an increase in temperature of the hydrocarbon feed across the pre-reformer. The first portion of the shifted synthesis gas is dry, thus water has been removed, thereby promoting the methanation reaction in the pre-reformer. As mentioned in connection with the first aspect of the invention, the presence of water in the shifted syngas recycle disfavors among other things the desired methanation reaction CO₂+4 H₂═CH₄+2 H₂O in the pre-reformer.

The shifted syngas recycle is required in small quantities, such as <10% of the shifted synthesis gas volume flow, it is cost effective because the pressure increase required is up-to only a few bars and involving a small gas flow only, as explained in connection with the first aspect of the invention.

In an embodiment, the pre-reformer is provided with an ejector for recycling a portion of the pre-reformed hydrocarbon feed (thus the stream exiting the pre-reformer), to the hydrocarbon feed (thus the stream being introduced to the pre-reformer). The ejector is arranged to receive the said recycling, i.e. the portion of the pre-reformed hydrocarbon feed, as driven fluid and a pressurized steam as the motive fluid. As explained in connection with the first aspect of the invention, the provision of an ejector, which has no moving parts, is a simple and inexpedient solution for providing mixing of the recycled pre-reformed stream with the pressurized steam. The pressurized steam is for instance supplied at about 50 barg and about 430° C.

In an embodiment, the plant is absent of a primary reforming unit requiring heat input upstream the ATR, said primary reforming unit being any of a steam methane reformer (SMR) and/or convection reforming unit such as a heat exchange reformer (HER). In another embodiment, the plant is absent of a reforming unit requiring heat input downstream the ATR or in parallel arrangement with the ATR, such as convection reforming unit such e.g. a heat exchange reformer (HER). Thereby, a reduction in plant size is also achieved.

In another general embodiment according to the second aspect of the invention, there is also provided a plant for producing a synthesis gas from a hydrocarbon feed, comprising:
a pre-reformer arranged to receive the hydrocarbon feed, for producing a pre-reformed hydrocarbon feed;
a feed gas compressor arranged upstream the pre-reformer, for directing the hydrocarbon feed to the pre-reformer;
an autothermal reformer (ATR) arranged to receive the pre-reformed hydrocarbon feed and convert it to a raw synthesis gas;
a water gas shift section, (WGS section), arranged to receive the raw synthesis gas from the ATR and shift it in at least a high temperature shift step (HTS step), thereby providing a shifted synthesis gas as said synthesis gas; and a downstream section comprising a process condensate separator (PC-separator) for the separation of a process condensate (water) from the shifted synthesis gas;
   wherein said plant is arranged to feed a first portion of the shifted synthesis gas from said PC-separator to a point upstream the pre-reformer; i.e. the plant is provided with a conduit for recycling said first portion of the shifted synthesis gas stream to a point upstream the pre-reformer.

Suitably also, heat exchangers for the cooling of shifted synthesis gas withdrawn from the MTS or LTS unit, are provided upstream the PC-separator.

Any of the embodiments and associated benefits of the first aspect of the invention (process) may be used with any of the embodiments of the second aspect of the invention (plant).

Further details of the invention according to any of the first or second aspect of the invention are set out in the following.

Suitably, a plurality of pre-reformers are arranged upstream the ATR. For instance, the plant may comprise two or more adiabatic pre-reformers arranged in series with interstage preheater(s) i.e. in between pre-reformer preheater(s).

In the pre-reformer(s) all higher hydrocarbons can be converted to carbon oxides and methane, but the pre-reformer(s) are also advantageous for light hydrocarbons. Providing the pre-reformer(s), hence pre-reforming step(s), may have several advantages including reducing the required O₂ consumption in the ATR. Furthermore, the pre-reformer(s) may provide an efficient sulfur guard resulting in a practically sulfur-free feed gas entering the ATR and the downstream system.

It would be understood, in line with the first aspect of the invention, that the term “process gas” refers to any gas stream being treated in the hydrogenator and sulfur absorber, or in the pre-reformer, hence the process gas is the hydrocarbon feed; or in the ATR, hence the process gas is the pre-reformed hydrocarbon feed or the raw synthesis gas; or in the shift section, hence the process gas is shifted synthesis gas or synthesis gas; optionally in the carbon dioxide removal section, hence the process gas is CO₂-depleted shifted synthesis gas; or optionally in the hydrogen purification unit.

Suitably, the high temperature shift (HTS) unit comprises a promoted zinc-aluminium oxide based high temperature shift catalyst, preferably arranged within said HTS unit in the form of one or more catalyst beds, and preferably wherein the promoted zinc-aluminium oxide based HTS catalyst comprises in its active form a Zn/Al molar ratio in the range 0.5 to 1.0 and a content of alkali metal in the range 0.4 to 8.0 wt % and a copper content in the range 0-10% based on the weight of oxidized catalyst, as for instance disclosed in applicant's US2019/0039886 A1.

In a conventional hydrogen plant the standard use of iron based high temperature shift catalyst re-quires a steam/carbon ratio of around 3.0 to avoid iron carbide formation.

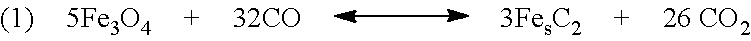

Formation of iron carbide will weaken the catalyst pellets and may result in catalyst disintegration and pressure drop increase.

Iron carbide will catalyse Fischer-Tropsch by-product formation

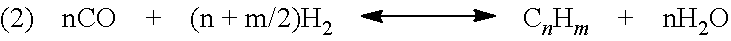

The Fischer-Tropsch reactions consume hydrogen, whereby the efficiency of the shift section is reduced.

In advantageous embodiments of the process the zinc-aluminum oxide based catalyst in its active form comprises a mixture of zinc aluminum spinel and zinc oxide in combination with an alkali metal selected from the group consisting of Na, K, Rb, Cs and mixtures thereof, and optionally in combination with Cu. The catalyst, as recited above, may have a Zn/Al molar ratio in the range 0.5 to 1.0, a content of alkali metal in the range 0.4 to 8.0 wt % and a copper content in the range 0-10% based on the weight of oxidized catalyst.

The high temperature shift catalyst used according to the present process is not limited by strict requirements to steam to carbon ratios, such as the above-mentioned value of around 3.0 to avoid iron carbide formation, which makes it possible to reduce steam/carbon ratio in the shift section as well as in the reforming section.

Significant reduction in the amount of steam carried in the plant and/or process is obtained, thereby reducing plant size and energy consumption. More specifically, a steam/carbon ratio of less than 2.0, yet 0.4 or 0.6 or even higher, such as 0.8, in the ATR has several advantages. Reducing steam/carbon ratio on a general basis leads to reduced feed plus steam flow through the reforming section and the downstream cooling and hydrogen purification sections. Low steam/carbon ratio in the reforming section and shift section enables also higher syngas throughput compared to high steam/carbon ratio. Reduced mass flow through these sections means smaller equipment and piping sizes. The reduced mass flow also results in reduced production of low temperature calories, which can often not be utilised. This means that there is a potential for both lower capital expenses and operating expenses.

As the requirements to the steam/carbon ratio in the high temperature shift step by the present process is significantly reduced compared to known technologies, it is possible by the present invention to reduce steam/carbon ratio through the front-end to e.g. 0.4 or 0.6 or 0.8. An advantage of a low steam/carbon ratio of the ATR and in the shift section is that smaller equipment is required in the front-end due to the lower total mass flow through the plant, as already recited above.

It would be understood that the term “front-end” means the reforming section.

Suitably, the plant comprises also an air separation unit (ASU) which is arranged for receiving an air stream and produce an oxygen stream which is then fed through a conduit to the ATR. Preferably, the oxygen comprising stream contains steam added to the ATR. Examples of oxidant comprising stream are: oxygen, mixture of oxygen and steam, mixtures of oxygen, steam, and argon, and oxygen enriched air.

The temperature of the synthesis gas at the exit of the ATR is between 90° and 1100° C., or 950 and 1100° C., typically between 100° and 1075° C. This hot effluent synthesis gas which is withdrawn from the ATR (raw synthesis gas) comprises carbon monoxide, hydrogen, carbon dioxide, steam, residual methane, and various other components including nitrogen and argon.

The carbon feed for the ATR is mixed with oxygen and additional steam in the ATR, and a combination of at least two types of reactions take place. These two reactions are combustion and steam reforming.

### Combustion Zone:

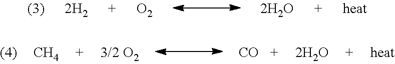

### Thermal and Catalytic Zone:

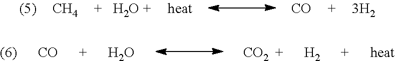

The combustion of methane to carbon monoxide and water (reaction (4)) is a highly exothermic process. Excess methane may be present at the combustion zone exit after all oxygen has been converted.

The thermal zone is part of the combustion chamber where further conversion of the hydrocarbons proceeds by homogenous gas phase reactions, mostly reactions (5) and (6). The endothermic steam reforming of methane (5) consumes a large part of the heat developed in the combustion zone.

Following the combustion chamber there may be a fixed catalyst bed, the catalytic zone, in which the final hydrocarbon conversion takes place through heterogeneous catalytic reactions. At the exit of the catalytic zone, the synthesis gas preferably is close to equilibrium with respect to reactions (5) and (6).

In an embodiment, the process operates with no additional steam addition between the reforming step(s) and the high temperature shift step.

Autothermal reforming (ATR) is described widely in the art and open literature. ATR is for example described in Chapter 4 in “Studies in Surface Science and Catalysis”, Vol. 152 (2004) edited by Andre Steynberg and Mark Dry, and an overview is also presented in “Tubular reforming and autothermal reforming of natural gas—an overview of available processes”, Ib Dybkjær, Fuel Processing Technology 42 (1995) 85-107.

The plant preferably comprises also conduits for the addition of steam to the hydrocarbon feed, to the oxygen comprising stream and to the ATR, and optionally also to the inlet of the reforming section e.g. to the hydrocarbon feed, and also to the inlet of the shift section in particular to the HTS unit, and/or to additional shift units downstream the HTS unit, as it will be described farther below.

By the invention, the shift section may further comprise one or more additional shift units downstream the HTS unit, wherein the one or more additional shift units are one or more medium temperature shift (MTS) units and/or one or more low temperature shift (LTS) units (150), wherein the plant is arranged to provide a LTS inlet temperature below 250° C., such as 190-250° C.

The provision of additional shifts units or shifts steps adds flexibility to the plant and/or process. The one or more additional shift steps may include a medium temperature (MT) shift and/or a low temperature (LT) shift and/or a high temperature shift. Generally speaking, the more converted CO in the shift steps the more gained H₂ and the smaller front end required.

This is also seen from the exothermic shift reaction: CO+H₂O↔CO₂+H₂+heat

Steam may optionally be added before and after the high temperature shift step such as before one or more following MT or LT shift and/or HT shift steps in order to maximize performance of said following HT, MT and/or LT shift steps.

Having two or more high temperature shift steps in series (such as a high temperature shift step comprising two or more shift reactors in series e.g. with the possibility for cooling and/or steam addition in between) may be advantageous as it may provide increased shift conversion at high temperature which gives a possible reduction in required shift catalyst volume and therefore a possible reduction in capital expenses. Furthermore, high temperature reduces the formation of methanol, a typical shift step byproduct.

Preferably the MT and LT shift steps may be carried out over promoted copper/zinc/alumina catalysts. For example, the low temperature shift catalyst type may be LK-821-2, which is characterized by high activity, high strength, and high tolerance towards sulphur poisoning. A top layer of a special catalyst may be installed to catch possible chlorine in the gas and to prevent liquid droplets from reaching the shift catalyst.

The MT shift step may be carried out at temperatures at 190-360° C.

The LT shift step may be carried out at temperatures at T_{dew}+15-290° C., such as, 200-280° C. For example, the low temperature shift inlet temperature is from T_{dew}+15-250° C., such as 190-210° C.

Reducing the steam/carbon ratio leads to reduced dew point of the process gas, which means that the inlet temperature to the MT and/or LT shift steps can be lowered. A lower inlet temperature can mean lower CO slippage outlet the shift reactors, which is also advantageous for the plant and/or process.

It is well known that MT/LT shift catalysts are prone to produce methanol as byproduct. Such byproduct formation can be reduced by increasing steam/carbon. The CO₂ wash which may follow the MT/LT shifts requires heat for regeneration of the CO₂ absorption solution. This heat is normally provided as sensible heat from the process gas, but this is not always enough. Typically, an additionally steam fired reboiler is providing the make-up duty. Optionally adding steam to the process gas can replace this additionally steam fired reboiler and simultaneously ensures reduction of byproduct formation in the MT/LT shift section.

The plant may further comprise a methanol removal section arranged between the shift section and said CO₂ removal section, said methanol removal section being arranged to separate a methanol-rich stream from said shifted syngas stream. The methanol formed by the MT/LT shift catalyst can optionally be removed from the synthesis gas in a water wash to be placed upstream the CO₂ removal step or in the CO₂ product stream.

The hydrogen purification unit is selected from a pressure swing adsorption (PSA) unit, a hydrogen membrane or a cryogenic separation unit, preferably a PSA.

The CO₂ removal section is selected from an amine wash unit, or a CO₂ membrane i.e. CO₂ membrane separation unit, or a cryogenic separation unit, preferably an amine wash unit.

In an embodiment, the amine wash unit comprises a CO₂-absorber and a CO₂-stripper as well as a high-pressure flash drum and low-pressure flash drum, thereby separating a CO₂-rich stream containing more than 99 vol. % CO₂ such as 99.5 vol. % CO₂ or 99.8 vol. % CO₂, a H₂-rich stream containing 98 vol. % hydrogen, as well as a high pressure flash gas containing about 60 vol. % CO₂ and 40 vol. % H₂. In the amine wash unit, in the first high pressure flash step via said high-pressure drum, the bulk part of the impurities is released together with some CO₂ to the gas phase as a high-pressure flash gas. In the low-pressure flash step via said low-pressure flash drum, mainly CO₂ is released to a final product as a CO₂-rich stream.

The CO₂ the CO₂ removal step is preferably captured and used for other purposes to reduce the CO₂ emission to the atmosphere. For instance, the separated CO₂ may be sequestered in geological structures or used as industrial gas for various purposes. The carbon in the hydrocarbon feed is thus captured as CO₂.

The sole accompanying FIGURE shows a schematic layout according to an embodiment of the present invention of the ATR-based process or plant for producing synthesis gas and hydrogen.

The FIGURE shows a process or plant 100 for producing a hydrogen product 23 from a hydrocarbon feed 1, and which includes a desulfurization section comprising a hydrogenator 10 and sulfur absorber 12. The process or plant include also pre-reformer 14, autothermal reformer (ATR) 16, water gas shift section (WGS section) 18, CO₂-removal section 20 and hydrogen purification unit 22. The hydrocarbon feed 1 such as natural gas is passed to a reforming section comprising the desulfurization section (hydrogenator 10, sulfur absorber 12), pre-reformer 14 and ATR 16. The hydrocarbon feed 1 is combined with a hydrogen recycle 23′, this being a portion of the hydrogen product 23 from hydrogen purification unit 22 arranged downstream and is then directed via a feed gas compressor (not shown) to the hydrogenator 10 and sulfur absorber 12. The WGS section 18 comprises a high temperature shift unit (HTS unit) and a medium or low temperature shift unit (MTS or LTS unit). None of these shift units are shown in the FIGURE. Prior to the desulfurizing in units 10 and 12, the process may comprise preheating (not shown) of the hydrocarbon feed 1 by indirect heat exchange, i.e. by cooling, with shifted synthesis gas of downstream WGS section 18, in particular with first shifted synthesis gas from the HTS unit. The desulfurized hydrocarbon feed 5 is then suitably further preheated (not shown) by indirect heat exchange with superheated steam generated from heat recovering in the WGS section 18, in particular from shifted synthesis gas from HTS unit.

The hydrocarbon feed 5 is combined with shifted syngas recycle stream 17′. This shifted syngas recycle is a first portion of the shifted synthesis gas 17 from WGS section 18 which has been cooled and dried. In the WGS section 18, there is for instance provided (not shown) a HTS unit and a LTS unit, as well as a downstream section for the cooling of shifted synthesis gas withdrawn from the LTS unit, and for the subsequent separation of a process condensate (water), thereby providing the cooled and dried shifted synthesis gas 17. The cooling and drying is conducted in one or more heat exchangers, suitably also an air cooler, and in a process condensate separator (not shown). From the synthesis gas 17, there is diverted the first portion 17′ as the shifted syngas recycle, and a second portion is directed to the CO₂-removal section 20.

The shifted syngas recycle 17′ may also be combined with the hydrocarbon feed 1 upstream the feed gas compressor (not shown); in this case, the hydrogen recycle 23′ may not be required. After adding steam 9 and recycle stream 7′ (“short recycle”), the latter being a portion of the pre-reformed hydrocarbon feed 7, the hydrocarbon feed is directed to pre-reformer 14 and then to ATR 16. No preheating of the pre-reformed stream 7 prior to the ATR 16 is conducted; in particular no fired heater is provided for preheating the pre-reformed hydrocarbon feed 7 or any of the hydrocarbon feed streams 1, 3, 5 upstream the pre-reformer 14. The pre-reformed hydrocarbon feed 7 is then directed together with some steam 9′ to the ATR 16. The ATR 16 operates under the addition of oxygen containing stream 11, for instance supplied from an air separation unit (not shown). In the ATR 16, the pre-reformed hydrocarbon feed 7 is converted to raw synthesis gas (raw syngas) 15 and then passed to the WGS section 18. From the WGS section 18, the shifted syngas stream 17 is thus produced of which a small portion 17′ is recycled to the pre-reformer 14, as explained above. The second portion of the shifted syngas 17 is then fed to the CO₂-removal section 20, as also explained above. The CO₂-removal section separates a CO₂-rich stream 19, thereby providing a CO₂-depleted syngas 21 which is then fed to hydrogen purification unit 22, from which hydrogen product stream 23 and an off-gas stream 25 are produced. While some of the hydrogen may be recycled as stream 23′, there is no recycling of the off-gas stream 23 or a portion thereof. The CO₂-rich stream 19 may be captured and/or utilized according to known techniques, such as carbon capture and utilization (CCU) or carbon capture and storage (CCS), or a combination thereof (CCUS).

1. A process for producing a synthesis gas from a hydrocarbon feed, comprising the steps:
i) pre-reforming the hydrocarbon feed for producing a pre-reformed hydrocarbon feed;
ii) autothermal reforming of the pre-reformed hydrocarbon feed for producing a raw synthesis gas;
iii) water gas shifting of the raw synthesis gas for producing a shifted synthesis gas as said synthesis gas, and recycling a first portion of the shifted synthesis gas by combining it with the hydrocarbon feed of step i); wherein the first portion of the shifted synthesis gas which is being recycled is shifted synthesis gas from which water has been removed in a water separation step.

2. The process according to claim 1, wherein in step iii) said first portion of the shifted synthesis gas is 15% or less of the volume flow of shifted synthesis gas.

3. The process according to claim 1, wherein the process is absent of a primary reforming step requiring heat input, said primary reforming step being any of steam methane reforming (SMR), and convection reforming.

4. The process according to claim 1, wherein the process further comprises:
prior to step i), desulfurizing the hydrocarbon feed; wherein step iii) comprises a high temperature shift (HTS) step for producing a first shifted synthesis gas, and optionally a subsequent medium and/or low temperature shift step (MTS and/or LTS) step, for producing the shifted synthesis gas; and wherein prior to the desulfurizing, the process further comprises: preheating the hydrocarbon feed by indirect heat exchange with shifted synthesis gas from step iii), in which said indirect heat exchange is by the cooling in one or more heat exchangers, of the first shifted synthesis gas; or by indirect heat exchange with superheated steam generated from heat recovering in step iii), in which said heat recovering comprises cooling a portion of the first shifted synthesis gas by directing it to a steam superheater for thereby generating said superheated steam.

5. The process according to claim 4, wherein after desulfurizing the hydrocarbon feed, the process comprises further preheating the hydrocarbon feed by indirect heat exchange with superheated steam generated from heat recovering in step iii), in which said heat recovering comprises cooling a portion of the first shifted synthesis gas by directing it to a steam superheater for thereby generating said superheated steam.

6. The process according to claim 1, wherein step i) comprises recycling a portion of the pre-reformed hydrocarbon feed by combining it with the hydrocarbon feed.

7. The process according to claim 6, wherein the process further comprises:
prior to step i), desulfurizing the hydrocarbon feed, and the pre-reformed hydrocarbon feed is combined with the preheated hydrocarbon feed after desulfurizing.

8. The process according to claim 1, wherein said first portion of the shifted synthesis gas which is being recycled has more than 70 vol. % H₂ and more than 25 vol. % CO₂.

9. The process according to claim 1, further comprising:
iv) CO₂-removal of a second portion of the shifted synthesis gas for producing a CO₂-depleted shifted synthesis gas; and optionally
v) hydrogen enrichment of the shifted synthesis gas stream or the CO₂-depleted shifted synthesis gas in a hydrogen purification unit for producing a hydrogen product and an off-gas stream; and wherein there is no recycling of off-gas stream to any of steps i)-iv).

10. The process according to claim 1, wherein the hydrocarbon feed is supplied to a feed gas compressor prior to said pre-reforming step or prior to said desulfurizing, and:
wherein said recycling in step iii) comprises combining said first portion of the shifted synthesis gas stream with the hydrocarbon feed prior to it being supplied to the feed gas compressor.

11. The process according to claim 1, wherein the process further comprises:
prior to step i), desulfurizing the hydrocarbon feed, and wherein said recycling in step iii) comprises combining said first portion of the shifted synthesis gas with the hydrocarbon feed after desulfurizing; wherein the hydrocarbon feed is supplied to a feed gas compressor prior to said pre-reforming step or prior to said desulfurizing, and the process further comprises recycling a portion of the CO₂-depleted shifted synthesis gas stream or a portion of the hydrogen product to the hydrocarbon feed prior to it being supplied to the feed gas compressor.

12. The process according to claim 11, wherein the pre-reforming step i) is conducted in an adiabatic pre-reformer with an inlet temperature of the hydrocarbon feed gas which is in the range 380-430° C.; and the autothermal reforming step ii) is conducted in an autothermal reformer (ATR) with an inlet temperature of the pre-reformed hydrocarbon feed which is in the range 420-480° C., substantially corresponding to the temperature of the pre-reformed hydrocarbon feed exiting the pre-reformer.

13. The process according to claim 1, wherein the steam-to-carbon molar ratio (S/C ratio) in the pre-reforming step i) is 1.0 or lower.

14. The process according to claim 1, comprising preheating by electric heating of said hydrocarbon feed or pre-reformed hydrocarbon feed prior to conducting the autothermal reforming step ii).

15. A process for producing a hydrogen product from a hydrocarbon feed, comprising the steps:
i) desulfurizing and pre-reforming the hydrocarbon feed for producing a pre-reformed hydrocarbon feed;
ii) autothermal reforming of the pre-reformed hydrocarbon feed for producing a raw synthesis gas;
iii) water gas shifting of the raw synthesis gas stream for producing a shifted synthesis gas and dividing the shifted synthesis gas into a first and second portion;
iv) CO₂-removal of the second portion of the shifted synthesis gas for producing a CO₂-depleted shifted synthesis gas;
v) hydrogen enrichment of the shifted synthesis gas or the CO₂-depleted shifted synthesis gas in a hydrogen purification unit for producing the hydrogen product and an off-gas stream;
wherein the hydrocarbon feed is supplied to a feed gas compressor prior to said desulfurizing and pre-reforming step, and wherein the process further comprises:
combining a first portion of the shifted synthesis gas with the hydrocarbon feed prior to it being supplied to the feed gas compressor; and/or
combining a first portion of the shifted synthesis gas with the hydrocarbon feed in between said desulfurizing and pre-reforming step.

16. A plant for producing a synthesis gas from a hydrocarbon feed, comprising:
a pre-reformer arranged to receive the hydrocarbon feed, for producing a pre-reformed hydrocarbon feed;
a feed gas compressor arranged upstream the pre-reformer, for directing the hydrocarbon feed to the pre-reformer;
an autothermal reformer (ATR) arranged to receive the pre-reformed hydrocarbon feed and convert it to a raw synthesis gas;
a water gas shift section (WGS section) arranged to receive the raw synthesis gas from the ATR and shift it in at least a high temperature shift step (HTS step), thereby providing a shifted synthesis gas as said synthesis gas;
wherein said plant is absent of a fired heater for preheating the hydrocarbon feed or the pre-reformed hydrocarbon feed;
wherein said plant is arranged to feed a first portion of the shifted synthesis gas to a point upstream the pre-reformer.

17. The plant according to claim 16, further comprising:
a CO₂ removal section, arranged to receive a second portion of the shifted synthesis gas from said WGS section and separate a CO₂-rich stream therefrom, thereby providing a CO₂-depleted shifted synthesis gas;
a hydrogen purification unit, arranged to receive said second portion of the shifted synthesis or said CO₂-depleted shifted synthesis gas from said CO₂ removal section, and separate it into a hydrogen product and an off-gas stream;
and wherein the plant is absent of a conduit and/or off-gas recycle compressor for directing at least a portion of the off-gas stream to any of said desulfurization section, pre-reformer, ATR, and WGS section.

18. The plant according to claim 17, wherein the plant is arranged to feed the first portion of the shifted synthesis gas to the inlet of the pre-reformer, and the plant is further arranged to feed a portion of the CO₂-depleted shifted synthesis gas or a portion of the hydrogen product to the hydrocarbon feed, upstream the feed gas compressor.

19. The plant according to claim 16, the plant is arranged to feed the first portion of the shifted synthesis gas to the hydrocarbon feed upstream the feed gas compressor.

20. The plant according to claim 16, wherein the WGS section comprises:
a high temperature shift unit (HTS unit), as well as a medium temperature shift unit (MTS unit) and/or a low temperature shift unit (LTS unit);
a downstream section comprising one or more heat exchangers for the cooling of shifted synthesis gas withdrawn from the MTS and/or LTS unit, and a process condensate separator (PC-separator) for the separation of a process condensate from the shifted synthesis gas, thereby providing a cooled and dried shifted synthesis gas; and means for diverting thereof: said first portion of the shifted synthesis gas fed to upstream the pre-reformer, and optionally also said second portion of the shifted synthesis gas fed to the CO₂-removal section.

21. The process according to claim 1, wherein the first portion of the shifted synthesis gas is directly supplied from the water separation step to the hydrocarbon feed.

22. The process according to claim 15, wherein the first portion of the shifted synthesis gas is shifted synthesis gas from which water has been removed in a water separation step, and the first portion is directly supplied from the water separation step to the hydrocarbon feed.

23. The plant according to claim 16, configured such that the first portion of the shifted synthesis gas is shifted synthesis gas from which water has been removed in a water separation step, and the first portion is directly supplied from the water separation step to the hydrocarbon feed.
